(19) United States
(12) Patent Application Publication
(10) Pub. No.: US 2007/0204002 A1
(43) Pub. Date: Aug. 30, 2007

(54) Method and system for dynamic updating of network based advertising messages

(76) Inventor: Michael Anthony Calderone, Las Vegas, NV (US)

Correspondence Address: Michael A. Calderone-With Gratitude, Inc., 3850 E. Flamingo Road, Suite 200, Las Vegas, NV, 89121, US

(21) Appl. No.: 11/364,793

(22) Filed: Feb. 27, 2006

(51) Int. Cl. G06F 15/16

(52) U.S. Cl. 709/217

(57) ABSTRACT

An Internet advertising system and method enables a client to dynamically send advertising messages to a customer via an intermediary. The client distributes software prepared by the intermediary to a customer base. When installed and activated by the customer, the software creates two bi-directional network links: one between the customer and an on-line Internet based attraction, which enables the customer to interact with the attraction; the other between the customer and the intermediary, which enables the intermediary to send client-prepared advertising messages to the customer. The customer's computer display is divided into designated display areas: some assigned to the attraction; others assigned to the client messages. The client can modify the content of the advertising messages at any time by using several dedicated control panels, and updated messages are stored by the intermediary. While the customer is engaged in the on-line attraction, the software is continually searching for advertising message updates provided by the client to the intermediary. When an update is noted, it is sent to the customer. If the customer is off-line when an update is available, the update is sent the next time the customer activates the software.

### COMPUTER PROGRAM LISTING APPENDIX ON COMPACT DISC

The present invention includes a computer program-listing appendix on a compact disc, which is hereby incorporated by reference. The following tables provide information as required under 37 C.F.R. § 1.52 (e)(3)(ii). The table provides a folder tree indicating the location of the files, an address bar indicating the file path, and a main display area where the compact disc files are individually listed with column headings providing the file name, size in bytes, file type and date created.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

### BACKGROUND OF THE INVENTION

1. Field of the Invention

The present invention relates to advertising over a computer network such as the Internet. More specifically, the present invention relates to a method and system for improving the effectiveness of advertising messages sent over such a network.

2. Background of the Art

Effective customer advertising is a very important aspect of operating a successful business. In performing the tasks of advertising, a business has typically used traditional media outlets such as television, newspaper and radio. Each of these media outlets is well established and considered the norm in the United States. However, the traditional outlets have several inherent disadvantages. Television advertisements are relatively expensive to produce, have limited time duration, and have become extremely fragmented. Newspaper readership has been decreasing for years, these advertisements, only have one-day impact, and are easily glossed over by a reader focused on other information. Radio advertisements, also a decreasing outlet, have no visual content, have potential impact on only those listeners tuned to the broadcasting station when the advertisement is aired, and are usually bracketed by other messages, which renders a given radio advertising communication difficult to absorb by the listener. All these traditional outlets typically only provide a business advertiser with one-time access to the potential or existing customer. In addition, a commercial message is frequently nested with other similar and often competing commercial messages, which tends to weaken the impact of a given message. Thus, businesses are continually looking for more cost-effective and more productive outlets for advertising their goods and services.

With the introduction of the Internet, new advertising and communication possibilities with customers have been created, which offer the potential of greatly enhanced and more effective advertising techniques for businesses. There have been numerous studies recently performed by the advertising community to evaluate the impact that advertising over the Internet has had on traditional media outlets. Forester Research performed one such study, which found that, on average, consumers spend 34% of their media consumption time on the Internet. Media consumption is the combined consumer usage of internet, television, newspaper and radio. The common conclusion in the study is that volume and usage of Internet advertising is growing at an increasing rate and promises to outpace the traditional media outlets. In addition, consumers are showing an increasing preference for using the Internet when searching for purchases, as compared to traditional media outlets. These conclusions are supported by the increasing demand for, and proliferation of, high-speed Internet connections throughout the United States and worldwide. As the Internet grows in popularity and felt necessity, the volume of businesses advertising and communicating over the Internet promises to increase in a corresponding manner.

In light of these developments, there is a significant move forward to enhance and develop methods of advertising over the Internet. Current methods of advertising over the Internet take many forms such as mass electronic mail, commonly referred to as e-mail and more specifically “spam”; the use of advertisements that open in a secondary Internet browser window, commonly referred to as “pop-ups”; and numerous other methods intended to attract the attention of Internet users. However, these methods of advertising over the Internet are intrusive and are considered by many Internet users as nuisances or Internet clutter. In fact, many Internet users purchase specialized software programs to block both “spam” and “pop-ups”. Consequently, the effectiveness both the “spam” and “Pop-up” forms of Internet advertising have been substantially impaired by the availability of blocking software programs for Internet users.

One approach to improving the effectiveness of Internet advertising is found in the disclosure of U.S. Pat. No. 6,907,418, which is hereby incorporated by reference. U.S. Pat. No. 6,907,418 teaches a method and system of notifying an Internet user of advertising content by utilizing the Internet user's email. This system notifies the Internet user that a new email has arrived from a predetermined source, with the notification to the user effectuated by means of an animated character containing advertising content. While this technique does download an advertising message to the user, the message may not be welcomed since the user is primarily interested in the e-mail message. Thus, the net effect may be to antagonize the user from the advertiser, which is just the opposite result the advertiser wishes to obtain. In addition, by allowing the Internet user to choose which advertisements to view, the Internet business advertiser runs into problems similar to those posed by the traditional media outlets: namely, the ability of the Internet user to easily skip the communication or have the business's advertisements in direct competition with other competing business's communications. In addition, message clutter is still present in this form of advertising.

A different form of Internet advertising involves the combining of business advertisements with the increasingly popular field of on-line computer gaming. This form of advertising is known as “Advergaming” and is currently considered one of the most popular and productive forms of Internet based advertising. Internet gaming is a source of substantial development and interest for both advertisers and game developers. The “on-line” gaming played over the Internet can take the form of solo player games such as Solitaire, non-risk (no cash wagering involved) player groups involving two or more players in competition with each other, and tournament games involving two or more players in competition with each other. The tournament games are either skill based or non-skill based and may involve cash wagering. An example of a skill-based game is Pool in which the player's skill is a substantial factor in determining the outcome of the game. A non-skill based game such as a video reel slot game generates random results and thus has no dependency on the player's skill level in determining the outcome of a particular game.

Attempts to exploit the use of advertising in combination with on-line gaming have been made by companies such as Wild Tangent.com and Eprize.com. The method used by Wild Tangent embeds advertising in the actual elements of the game. These advertisements are then displayed while the Internet user is playing the on-line game. The method of advertising employed by Eprize.com requires programming into each game the specific advertising messages. Each of the methods of Advergaming employed by these companies suffers from at least the following limitations. First, the advertising content presented on the player's console cannot be easily changed by the advertiser but rather is controlled by the network administrator and typically requires reprogramming the game software to include new content. Second, any updates in the advertising messages may require redistribution of the computer software to the customer base by directly handing the software to the customer at the point of sale, having the customer download the software, emailing the software to the customer, using direct mail or other known techniques of market distribution.

Another perceived deficiency in Internet based advertising as currently practiced is infiltrating the Internet user's computer and forcing unrelated or unwanted advertising messages onto the user's computer display. When an Internet user has advertising messages forced upon them in this manner, like spam or pop-ups, these advertising messages and their sponsors are negatively received by the user and frequently viewed as unwanted.

In view of the above, what is needed is an Internet based advertising method and system that is devoid of the limitations and disadvantages inherent in traditional media outlets and known advertising techniques currently in use in such media outlets and Internet-based advertising techniques.

### SUMMARY OF THE INVENTION

The present invention is a method and system of advertising which allows a business advertiser to deliver advertising messages to an Internet user in a non-intrusive manner, allows the business advertiser to dynamically update the existing content of advertising messages without requiring distribution of additional software to the user, and is more likely to be favorably received by the Internet user by virtue of being associated with a primary attraction favored by the user that is independent of the advertising message.

The present invention comprises a method and system for providing advertising messages over a network, which involves network-based communications between a client, a customer, a marketing service provider, and an attraction provider. The client is a business entity having a personal computer with network access seeking to advertise effectively over the network with prospective and established customers. The customers are individuals each having a personal computer with network access, and who are existing or potential patrons of the client and are interested in the services of an attraction provider. The marketing service provider is a business entity having a host site with network access that interacts with the client during an advertising message preparation process and interacts with a customer computer to transmit current advertising messages for viewing by the customer. The attraction provider is an on-line network entertainment service provider, such as a gaming host. The communications are performed over a network such as the Internet and involve the client, the customer, the marketing service provider, and the attraction provider.

The client obtains authorization from the marketing service provider to participate in the network-based advertising hosted by the marketing service provider. During this authorization process, the client is assigned a unique identification code by the marketing service provider. This code permits the client to prepare an initial advertising message with the aid of the marketing service provider and to subsequently modify the advertising-message. After the client has obtained authorization, the marketing service provider provides software in distributable form to the client, which the client distributes to existing and prospective customers. A customer who has installed a copy of the software in their personal computer is permitted to access the attraction provider over the network. Whenever the customer's personal computer accesses the attraction provider, it also accesses the marketing service provider and the current version of the client's advertising message is transmitted to the customer's personal computer. The bi-directional links between the customer's computer and the attraction provider, and between the customer's computer and the marketing service provider, remain active so long as the customer's computer is connected to the marketing service provider.

Both the attraction provider content and the advertising messages are displayed on a customer's computer display console that the customer uses when accessing the attraction provider. The customer's display console is divided into a plurality of display areas: some of the display areas are assigned to the client; others are assigned to the attraction provider. Display areas assigned to the attraction provider display items related to participating in an on-line attraction. Display areas assigned to the client provide advertising messages intended for display to the customer.

A significant advantage of the invention resides in the fact that the client is able to update its advertising messages at any time using a network-based dialogue between the client and the marketing service provider, using the identification code to provide secure communication between the client and the marketing service provider and without the need for any personal interaction between the client and marketing service provider personnel. Moreover, any advertising message update can be done by the client from any computer having network access, so long as the client can provide the identification code during the initial portion of the dialogue. If the bi-directional link between a customer computer and the marketing service provider is active when an advertising message is updated by the client, that updated advertising message is immediately sent over the network to that customer computer. If this link is inactive when the update occurs, the updated advertising message is sent to the customer computer when that computer next accesses the attraction provider. Thus, the advertising message updates are sent to customer computers with a minimum of delay.

Another significant advantage of the invention lies in the advertising message exclusivity afforded the client. Unlike known advertising techniques, the advertising areas of the customer computer display are exclusively reserved for the advertising messages prepared by the client. Consequently, the potential advertising impact of the client's advertising messages is maximized with the invention.

The client may optionally incorporate an incentive mechanism into the software distributed to the customers in order to increase the probability that a customer receiving a copy will actually install the software into their computer. The particular incentive mechanism may be any one of a number of known techniques, such as scratch and win tickets, raffle-type drawings and random give aways.

The invention also enables the client to tailor the advertising messages to different classes of customers. This is done by assigning two or more unique and different identification codes to the client, during the initial authorization procedure or thereafter, so that the client may prepare separate and different advertising messages each specific to one of the identification codes. Each identification code delineates a specific class of customers. When the marketing service provider prepares the software in distributable form, each software copy is permanently associated to one of the identification codes. Whenever the client creates an advertising message, the client specifies the class of customers to which the advertising message is to be directed by using the appropriate identification code. When a customer establishes a link with the marketing service provider by activating the installed software, that customer will receive only those advertising messages which correspond to the identification code associated to that customer's software copy.

For a fuller understanding of the nature and advantages of the invention, reference should be made to the ensuing detailed description and claims, taken in conjunction with the accompanying drawings.

### BRIEF DESCRIPTION OF THE DRAWINGS

FIG. 1 is a system block diagram illustrating the invention.

FIG. 2 is a flow diagram illustrating the method for dynamically updating advertising content over a network according to the invention.

FIG. 3A is a view of a client interface page showing an initial network login page for accessing and updating an advertising message according to the invention.

FIG. 3B is a view of a client interface page showing selection menus for updating an advertising message according to the invention.

FIG. 3C is a view of a client interface page showing input fields for updating the logo content of an advertising message according to the invention.

FIG. 3D is view of a client interface page showing input fields for updating the banners portion of an advertising message according to the invention.

FIG. 3E is view of a client interface page showing input fields for updating the text message portion and message parameters of an advertising message according to the invention.

FIG. 3F is a view of a client interface page showing input fields for updating the coupon content portion of an advertising message according to the invention.

FIG. 3G is a view of a client interface page showing input fields for modifying the customer's association with a particular advertising group according to the invention.

FIG. 4A is a view illustrating an example of a first branded customer display console according to the invention.

FIG. 4B is a view illustrating an example of a second branded customer display console according to the invention.

FIG. 5 is a view illustrating a customer display console with a plurality of content areas according to the invention.

FIG. 6 is a view illustrating a customer display console for a coupon center having a plurality of content areas according to the invention.

FIG. 7 is a view illustrating a custom trivia game having a plurality of content areas according to the invention.

### DETAILED DESCRIPTION OF THE INVENTION

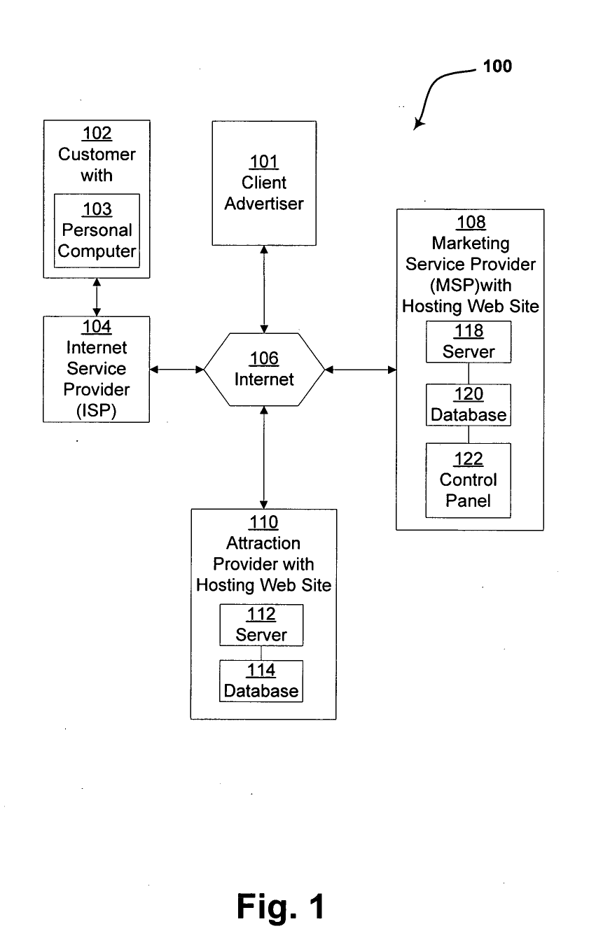

Turning now to the drawings, FIG. 1 illustrates a network-based advertising system according to the invention. In the following description, various entities are involved in the practice of the invention. The client 101 is a business entity with a network accessible computer seeking to optimize advertising over the network with established or potential customers. A customer 102 is an individual with a network accessible computer 103 that is either an existing or a potential patron of the client 101 and has an interest in the services of an attraction provider 110. The marketing service provider 108 is a business entity with a hosting web site including a computer and network access that facilitates client 101 advertising message modifications and subsequently facilitates transmission of the modified adverting messages to the customer 102 over the Internet 106. An attraction provider 110 is an entertainment or service provider that operates over the Internet 106.

The customer 102 has a personal computer 103 capable of executing various computer programs including a conventional Internet web page browser and is operatively connected to a network. The customer computer 103 is commonly known to those skilled in the art as a personal computer or PC. An Internet service provider or ISP 104 is exemplified by popular and well-known ISPs such as AOL®, CompuServe®, MSNetwork® and the like, and provides network connectivity to the computer 103. These ISPs provide various services such as email, news, weather, e-commerce, on-line games and many other services and features common using the Internet 106. “On-line” is a common term relating to use of the Internet 106 and refers to an activity or experience conducted over the network of connected Internet users.

Attraction provider 110 communicates with the customer's computer 103 through the Internet 106 and uses an ISP 104 and a server 112. The customer 102 is drawn to the attraction provider 110 for enjoyment of various activities. The function of these activities is to provide entertainment, promotional discounts, gifts and other attractions that are of potential interest to customers 102. Examples of attractions are on-line tournament games, movie content, musical content, sports content, news, educational content, promotional discounts related to coupons for both products and services and other attractions based on free giveaways. The attraction provider 110 responds to various requests and commands sent by the customer's computer 103 through a bi-directional communication link over Internet 106. Examples of common information exchanges are files for updating computer software, images and multimedia content for the attraction and information required for verification of customer identification. Attraction provider 110 typically uses a server 112, and a database 114 for performing the related Internet hosting and information exchanging functions.

Client 101 is a business entity that has registered with and acquired a license agreement from marketing service provider 108. The client 101 has a requirement or business goal of communicating with either existing or potential customers. The client 101 desires to find avenues of advertising that are less expensive, more interactive and more effective than traditional media outlets.

Marketing service provider 108 communicates with the customer's computer 103 and the client 101 through the Internet 106 and uses an ISP 104 and a server 118. The marketing service provider 108 is the licensing source for the client 101 to acquire the software of the present invention and facilitates participation in sending advertising messages to the customer computer 103. The marketing service provider 108 responds to various requests and commands sent by the customer computer 103 and the client 101 through a bi-directional communication link over Internet 106. Examples of common information exchanges are files for updating computer software, images and multimedia content for the advertising/communication messages, information relating to the customer's interaction with the software, and information required for verification of customer and client identification. Marketing service provider 108 typically uses a server 118, database 120 and control panel 122 for performing the related Internet hosting and information exchanging functions.

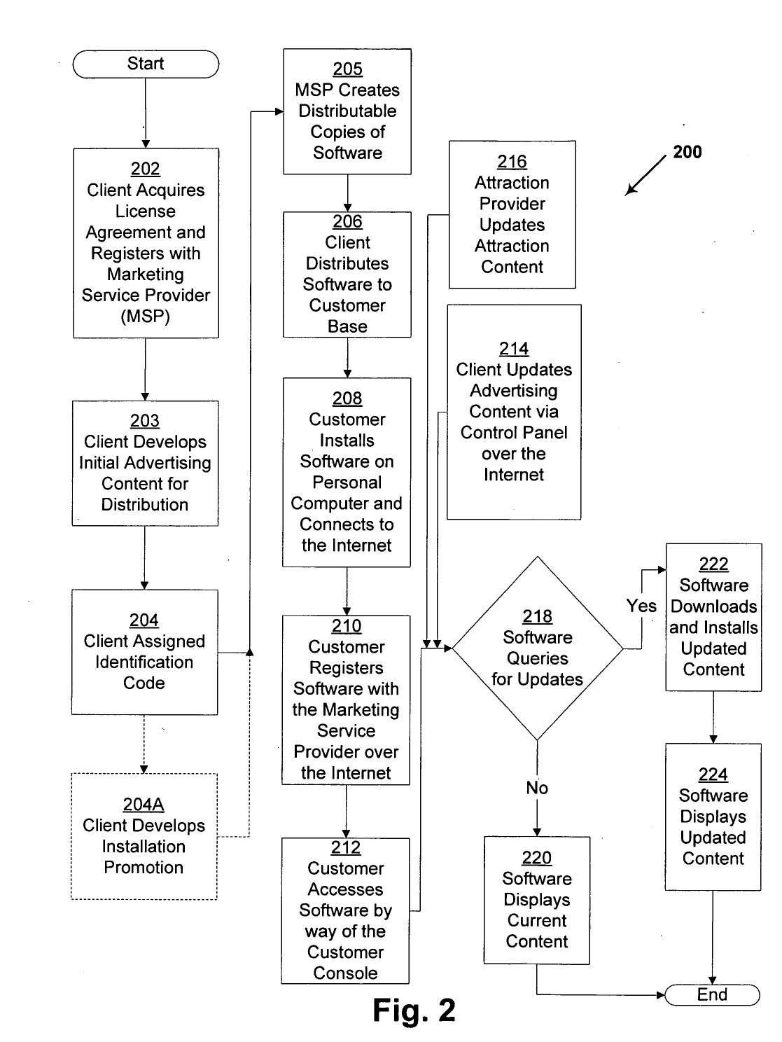

FIG. 2 is a flow diagram 200 illustrating the method for dynamically updating advertising messages according to the invention. As seen in this figure, in step 202 a client 101 seeking to advertise with existing or potential customers registers as a client with marketing service provider 108. This may be done either on a personal basis (such as a face-to-face conference or a telephone conference) or over the Internet 106. In the course of the registration step, the client 101 is assigned at least one unique identification code by the marketing service provider 108. The function of the identification code is to provide a secure communication process which allows the client 101 to securely engage in a dialogue with the marketing service provider 108 for purposes described more fully below. The identification code may comprise any unique combination of symbols, and usually takes the form of alphanumeric identifiers such as numbers, letters or a combination of both.

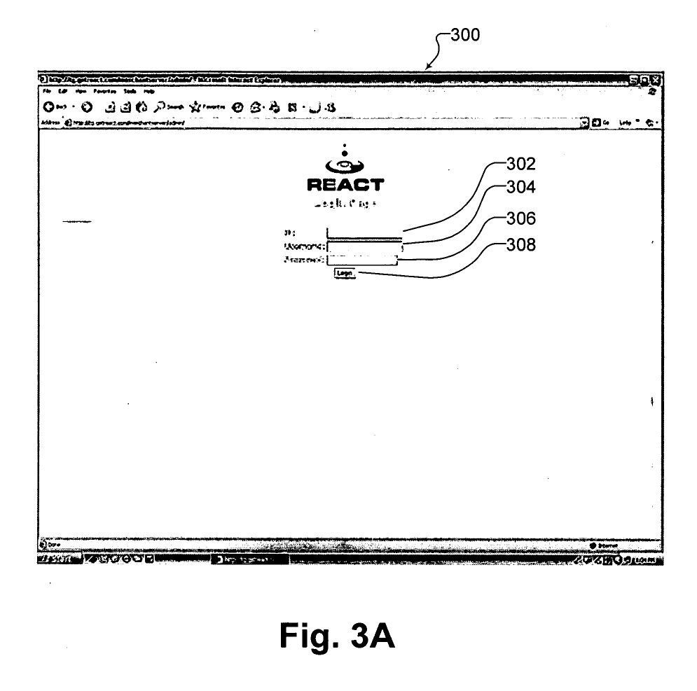

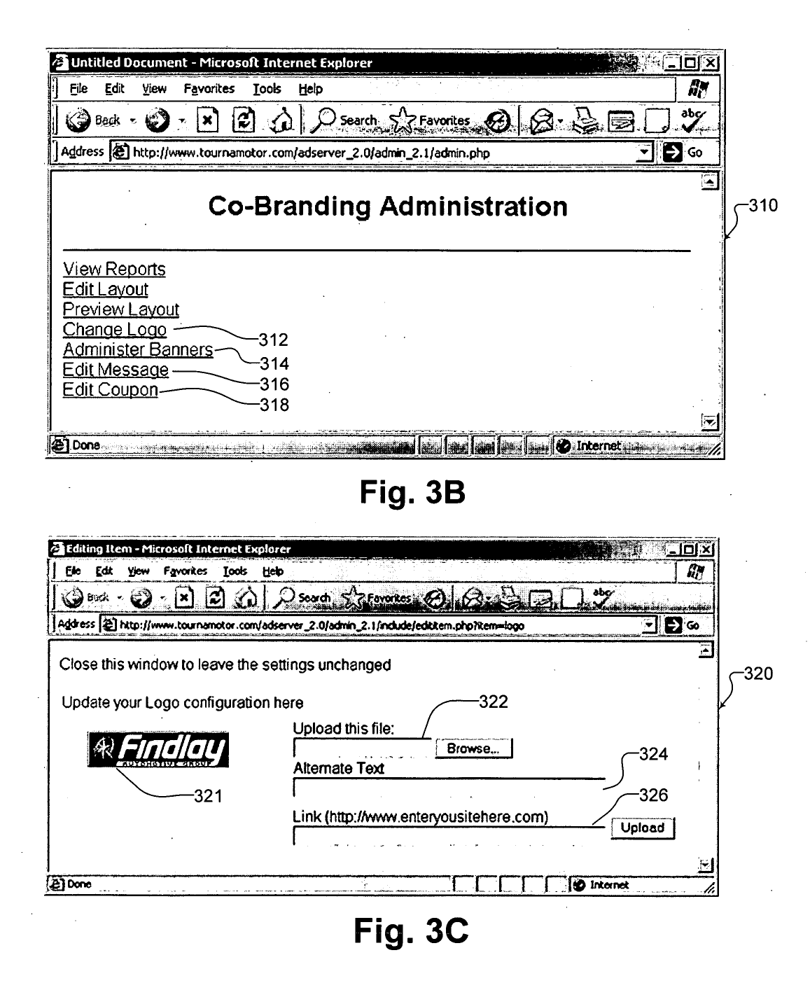

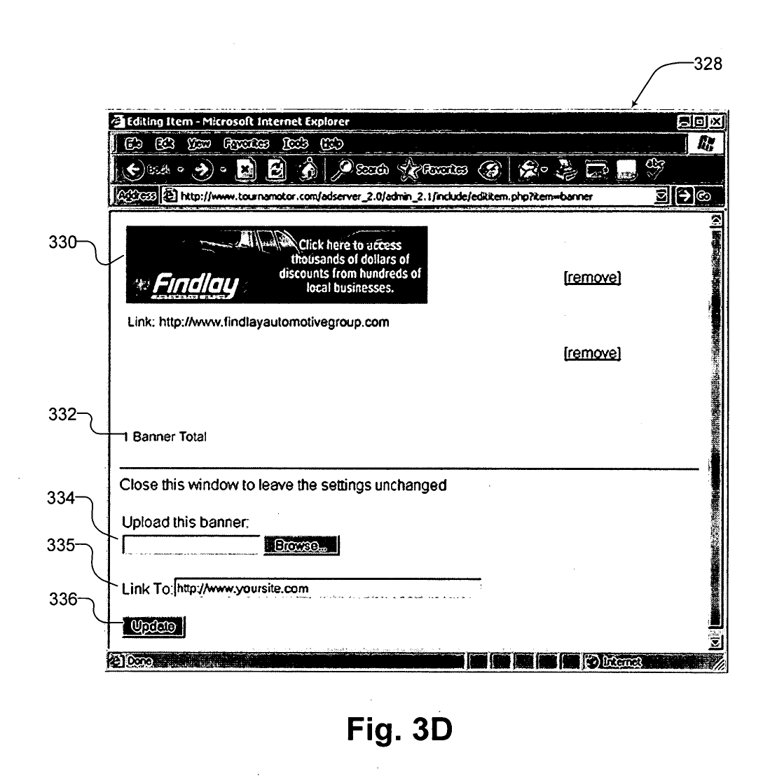

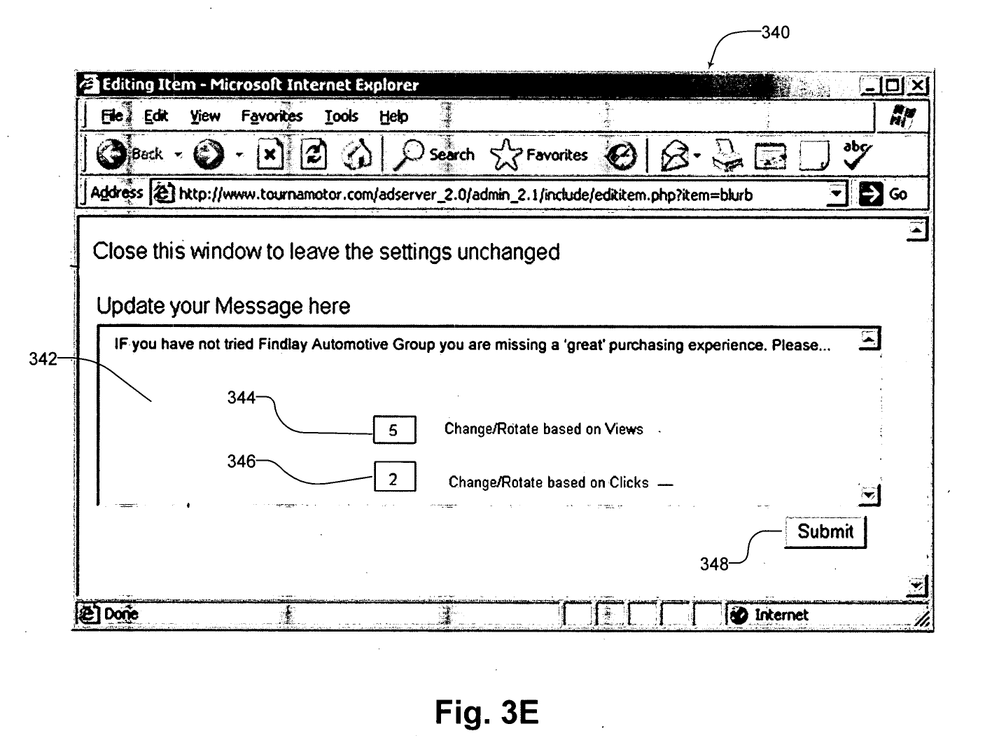

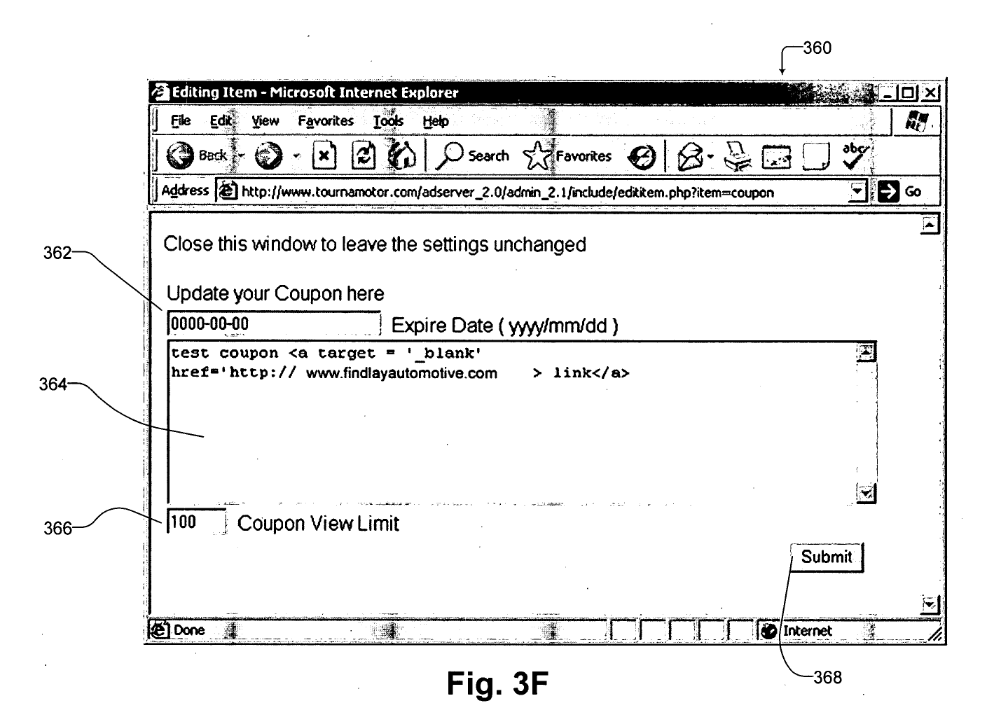

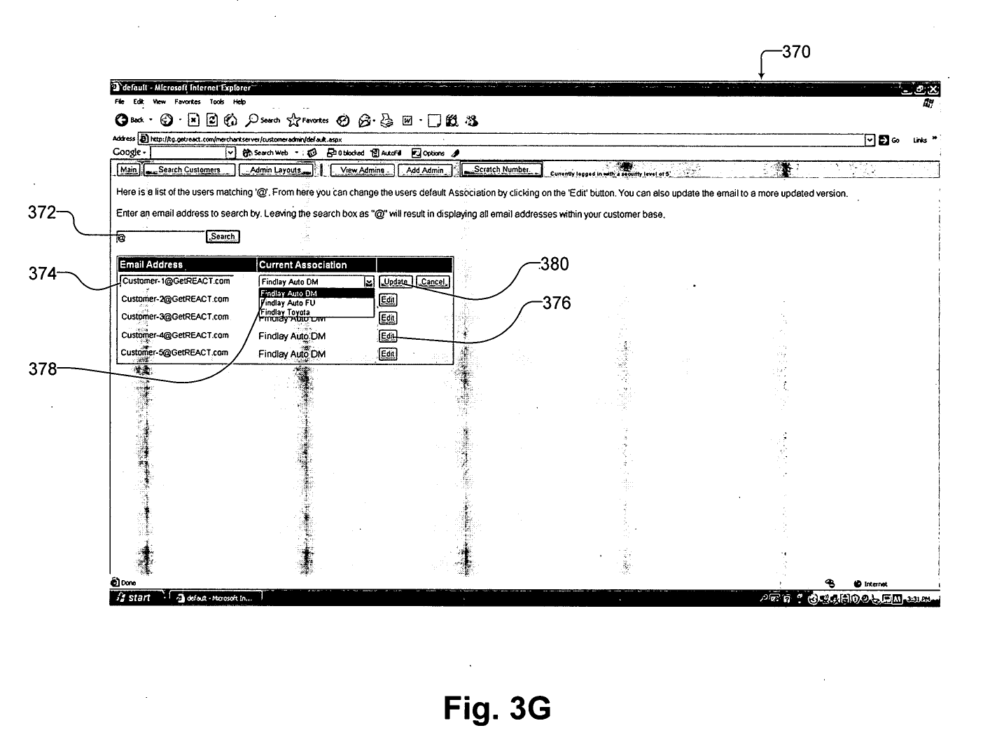

After registering in step 202, client 101 develops the initial content of the advertising message(s) 203 it wishes to make available for transmittal to customers. Development of the initial content may be done by client 101 alone in the manner described below in connection with FIGS. 3A-3F, or in consultation with marketing service provider 108. Client 101 also identifies one or more attraction providers 110 which it wishes to make available to customers 102. In some implementations of the invention, client 101 may select one or more of any attraction providers 110 currently available on the Internet. In other implementations, marketing service provider 108 may present a preselected list of attraction providers 110 from which client 101 may choose. In still another implementation, only one attraction provider 110 may be available. In this latter case, client 101 must associate its advertising message with that sole attraction provider 110.

Once the initial advertising content has been completed, it is retained by marketing service provider 108 in database 120 along with the identification of any selected attraction provider(s) 110. Marketing service provider 108 then creates multiple copies of distributable software 205 containing executable code for enabling a customer computer 103 to access the attraction provider(s) 110 and the client's 101 advertising message stored in data base 120 of marketing service provider 108 whenever the customer 102 activates the executable code. Any one of several types of media may be used for preparation of the software copies, such as CDs, DVDs, flash memory, or any other portable storage devices having sufficient storage capacity for the required code. As will now be apparent, the software content is based on two general factors: first, the format and content of the advertising messages the client 101 wants to convey to present and prospective customers 102; and second, the entertainment vehicles the client 101 believes will be attractive to the client's customers 102 and which the client 101 chooses to use.

Step 204A is an optional step which client 101 can perform to provide a promotional incentive to the customer 102 for installing the software. In this step, client 101 prepares incentive content in a manner similar to the preparation of the initial advertising content. One example of an incentive is a scratch and win ticket, which requires that the customer 102 install and activate the software to determine if they have a winning ticket. Another example requires the customer 102 to install and activate the software to receive an instant gift, instant rebate or enter a contest to win a prize.

In step 206, the client 101 distributes the software copies to the customer 102 base. Distribution functions to disburse the software of the present invention to the client's 101 customer base. Distribution of the software can be achieved in a number of known ways, e.g. by directly handing a copy of the software to the customer 102, by having the customer 102 download the software, by e-mailing the software to the customer 102, by using direct mail or by using any other known techniques of market distribution. If client 101 has chosen to perform optional step 204A, when distributing the software copy, client 101 informs the customer 102 that they are eligible to participate in the optional incentive program. This may be done either directly or by means of a message printed on the packaging of the software copy. The incentive increases the probability that the customer 102 will actually install the software on their computer 103.

Installation of the software is performed by the customer 102 in step 208, using a subprogram specific to the task of installing a computer-based application. It is common to those skilled in the art to use preprogrammed or coded installation “wizards” to facilitate software integration with a customer's computer 103. After the distributed software has been installed on the customer's personal computer 103, the customer 102 connects to the Internet 106 using any one of several known connection technologies, such as a dial up modem connection or a broadband cable modem connection. Installation of the software and establishing an Internet connection, creates direct two-way communications links between the customer's computer 103 and the attraction provider 110, and between the customer's computer 103 and marketing service provider 108. The two-way communication links remain active until the customer 102 halts the operation of the customer-installed software.

During the initial activation, the customer 102 registers the software with marketing service provider 108 in step 210. This registration process establishes a unique identification for the customer 102 with the marketing service provider 108. The unique identification is subsequently provided to the attraction provider 110 by sending a data packet over the bi-directional communication links from the marketing service provider 108. Further, in step 210 the bi-directional links are established between the marketing service provider 108, attraction provider 110 and customer 102. The customer identification is verified with information stored in databases 114 and 120 and the customer's computer 103. Identification is accomplished by using the identification code which can be based on the customer's email address, physical address, phone number or other indicia that uniquely identifies the customer 102. In step 212, the customer 102 executes the installed software to participate in the entertainment offered by the attraction provider 110.

When step 212 is performed by the customer 102, the customer's identification is first verified as described above and upon a successful evaluation; the customer 102 is effectively logged-on to the marketing service provider 108. At this point, a customer console is displayed on the customer's computer 103, which provides an interface console with dedicated areas. One or more of the dedicated areas contain the client's 101 advertising content; others contain the attraction provider's 110 content. The customer console is described in greater detail below but is essentially the customer's 102 interface that is displayed on, the customer's computer 103 when the installed software is executed. While observing the customer console, the customer 102 is shown updated and current content from both the client 101 and attraction provider 110. The customer 102 can at this point evaluate the advertising content of the client 101 displayed in the client's dedicated areas or the customer 102 may proceed to participate in the activities provided by the attraction provider 110. If the customer 102 chooses to participate in the activities, the customer 102 activates a hyperlink in one of the attraction provider's dedicated areas for the chosen activity. When an attraction activity is selected, the customer console then allows the customer 102 to participate in the attraction.

Upon execution, the software runs various modules to perform the functions programmed therein and establishes bi-directional communication links between customer 102 and marketing service provider 108, and between customer 102 and attraction provider 110. In step 218, the software contacts the marketing service provider 108 and attraction provider 110 to search for updated software content. Any available updates are then downloaded to the customer's computer 103 and integrated into the software program in step 222. If there are no updates available for downloading, the software displays the currently programmed content in step 220. Upon completion of any content update, the software displays the updated advertising content and any updated attraction content on the customer's computer 103 in step 224. The content is displayed on the computer 103 by way of any display device such as a cathode ray tube (CRT) monitor, liquid crystal display (LCD), plasma monitor, or other operatively connected display device.

In steps, 214 and 216 the attraction provider 110 and client 101 develop and perform various updates to their specific software content. The updates can be performed at any time during the practice of the invention. The client 101 or attraction provider 110 can update only their respective content as shown in steps 214 and 216. In the diagram of FIG. 2, steps 214 and 216 are shown entering the process prior to step 218. This should be considered illustrative and steps 214 and 216 may be performed prior to other steps in the method. Updates to the advertising content can be performed while the customer 102 participates in the on-line attraction. The client 101 updates the advertising message content by way of a dedicated control panel described in more detail below and a secure Internet connection between the client 101 and marketing service provider 108 and server 118. The client ID code is verified with information in database 120. The secure connection verifies the identity of the client 101 and insures that only the client 101 has access to the control panel 122 for editing and modifying the advertising content. Prior to the customer 102 participating in the attraction, the software queries for updated attraction related content from the attraction provider 110. Updates to the attraction provider 110 content are essentially updates to commands and data that facilitate the customer's 102 access to, and enjoyment of, the attraction. For example, in a tournament game the attraction provider 110 may provide an update to a game that enhances the game graphics or alters the play of the game. The updates that are performed in steps 214 and 216 are preferably mutually exclusive and performed only by the client 101 and attraction provider 110 respectively.

While FIGS. 1 and 2 illustrate the involvement of only one customer 102, in practice many customers 102 can participate in the system and method of the invention.

FIGS. 3A-3G illustrate the process by which client 101 prepares original and updated advertising content. FIG. 3A illustrates the initial interface the client 101 uses to access the marketing service provider 108 for modifying the client's 101 advertising messages. The login interface 300 contains three input fields 302, 304, 306 and one execution button 308. The client 101 is required to input valid information in the input fields before the marketing service provider 108 will permit access to the control panel 310, described below, and allow advertising message modification. ID code input field 302 allows the client 101 to type in a valid and unique ID code as assigned by the marketing service provider 108. Input field 304 permits the client 101 to enter a username. Password input field 306 requires that the client 101 enter a password associated with the user name as entered in field 304 and ID code as entered in field 302. After the client 101 has entered the required information in fields 302, 304 and 306 the client 101 activates the login button 308 to send the information to the marketing service provider 108 for verification and permission to access the marketing service provider host web server 118.

FIG. 3B illustrates the interface 310, which is the principal console for the client 101 to change advertising messages. The interface 310 is the screen for a client 101 to select specific areas for modification of advertising destined to be content sent over the network. This interface provides several options for enhancing and modifying the dedicated communication areas of the present invention. The following examples are not all-inclusive or limiting in defining the scope of the invention, but rather are illustrative of the concepts enabled herein.

Menu hyperlink 312 enables the client 101 to edit and modify a client logo. A “hyperlink” is a technique commonly known to one skilled in the art of web page design and performs the task of opening another web page when selected. A common use for a hyper link is to provide access to a subsequent web page. When the client 101 activates the hyperlink 312, the interface 320 of FIG. 3C is displayed to the client 101 for changing the client's logo. The interface 320 contains specific input fields, which enable client 101 to edit and modify the client's logo. Area 321 provides the client with a preview image of a selected logo for uploading to the marketing service provider 108. Field 322 allows a client 101 to upload a logo image file by browsing to the file on the client's 101 computer. Field 324 allows the client 101 to enter text related with the logo. Field 326 allows the client 101 to upload the client's Internet address associated with the logo.

Menu hyperlink 314 enables the client to edit and modify the various banners that are part of the customer console. FIG. 3D illustrates the client 101 interface for administering the banners 328. This client interface 328 contains displays and input fields associated with banner management. Display 330 previews the current banner assigned for uploading to the marketing service provider 108 and subsequent distribution over the Internet to the customer 102. Summary 332 indicates the total number of banners for upload. Input field 334 enables the client 101 to modify a banner by browsing to the location on the client's 101 computer and uploading the new banner. Input field 335 allows the client 101 to enter an Internet address for association and linking with the banner. Update button 336 performs the required steps for sending the information to the marketing service provider 108.

Menu hyperlink 316 enables the client 101 to edit and modify the message area of the customer console. Upon activation of the hyperlink 316, a client interface 340 is displayed on the client's Internet browser as illustrated in FIG. 3E. The interface includes a text input field 342, a view parameter input field 344, a click parameter input field 346, and submit button 348. The message editor text input field 342 allows the client 101 to create, edit and modify the messages that are displayed on the customer's console. The messages are keyed in the text input field by the client 101. Also included in client interface 340 is a view parameter input field 344 for setting the number of permitted customer 102 views for this particular message. Click parameter input field 346 allows the client 101 to set the number of times a customer 102 may activate the message before the message changes. Each of these parameters may be available for each of the client 101 interfaces in the control panel 310. Upon activation of the submit button 348, the updated messages, view parameters and click parameters are uploaded to the marketing service provider 108.

Menu hyperlink 318 enables the client 101 to edit and modify the coupon area of the customer console. Upon activation of the hyperlink 318, a coupon editor interface 360 as illustrated in FIG. 3F is displayed to the client 101. The coupon editor 360 contains several input fields for editing and modifying the coupons. Field 362 provides the client 101 with the ability to enter a coupon expiration date. Field 364 provides the client 101 a text input area for specific information regarding the coupon. Field 366 provides the client 101 with the ability to enter a coupon view limit. A coupon view limit restricts the number of times the customer 102 can access the coupon. Upon activation of the submit button 368, the updated messages are uploaded to the marketing service provider 108.

A customer association editor interface 370 is illustrated in FIG. 3G. This interface contains several input fields that enable the client 101 to modify a designated customer group for a customer 102. Search field 372 allows the client 101 to search for a specific customer 102 or perform a global search for all customers 102. Search results are displayed in list form in email address area 374. The client 101 then may select an edit button 376 for a particular customer 102 which then allows the client 101 to edit the group association for this customer 102. The client 101 then uses the pull-down menu 378 to select a new group association for the customer 102. Once the preferred group association is selected by the client 101, the update button 380 is activated which then performs the modification and stores the new association with the marketing service provider 108 in database 120. Once a client 101 performs this modification the customer will subsequently receive advertising messages intended for the specific customer 102 group.

The control panel 310 also contains hyperlinks for viewing reports, editing the layout of the console and a hyperlink for previewing the edited and modified customer console. The reports link displays a page that generates statistical data about the registered customers 102 and provides this data to the client 101 for use in market analysis and other demographic analysis. Other hyperlinks and possible variations can be envisioned by those skilled in the art and are within the scope of the present invention. Examples of other types of content that a client 101 may edit or modify are: add video content, add audio content, add multimedia content and other forms of communication that are sent over the network.

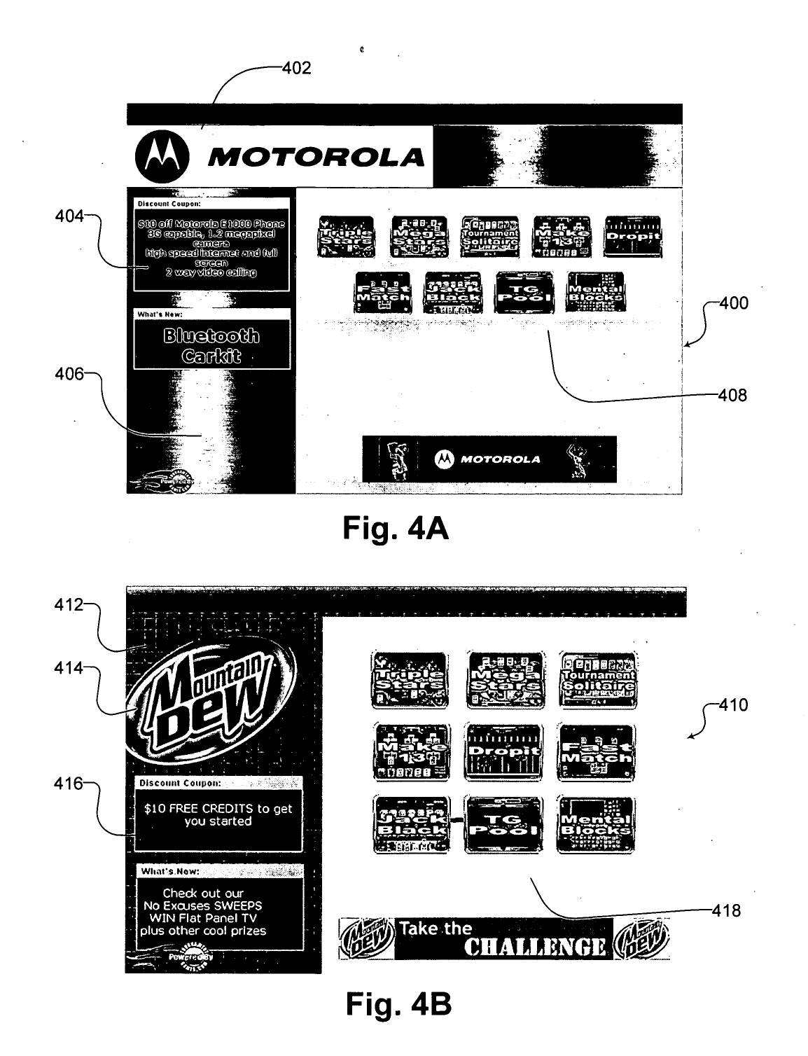

FIGS. 4A and 4B illustrate two variations in the customer console according to the invention. Each of the variations is “branded” towards a particular client 101. The advertising industry defines “branded” as the unique look and feel of a product or company. Typically, a “branded” item will use the client's 101 trademark or logo as well as any trade dress that identifies the client 101 with the customer 102. Customer console variation 400 (FIG. 4A) is branded towards products and services for Motorola Corporation. Areas 402, 404 and 406 are designated to the client 101 for use in displaying advertising messages and establishing a branded look related to the client 101. Area 402 displays the Motorola Corporation logo and trademark. Advertising message area 404 contains advertisements that the Motorola Corporation uploads to the marketing service provider 108 by using control panel interface 340. Area 406 of the customer console 400 contains a graphical design element to simulate the look and feel of a brushed metal surface. Links to attraction provider 110 content are contained in a dedicated attraction area 408. In combination, the client logo 402 and graphical design element 406 provides the client 101 with a proprietary customer console that the customer 102 recognizes and identifies with the specific client 101.

Similarly, customer console variation 410 (FIG. 4B) illustrates the present invention branded towards the soft drink product Mountain Dew® soda. This customer console version contains a graphical design element 412, a logo display area 414, an advertising message area 416 and attraction area 418. This interface likewise displays imagery regarding the specific client 101, in this case Mountain Dews soda, to the customer 102 by emphasizing the client's logo 414 and a graphical design element 412. The graphical design element 412 is associated with the client logo 414 buy using a tiled grid that highlights the coloring and is graphically coordinated with the client logo 4.14. The customer consoles 400 and 410 illustrated in FIGS. 4 A & B provide examples of variations in the graphical design that establish a branded advertising environment unique for the respective client 101.

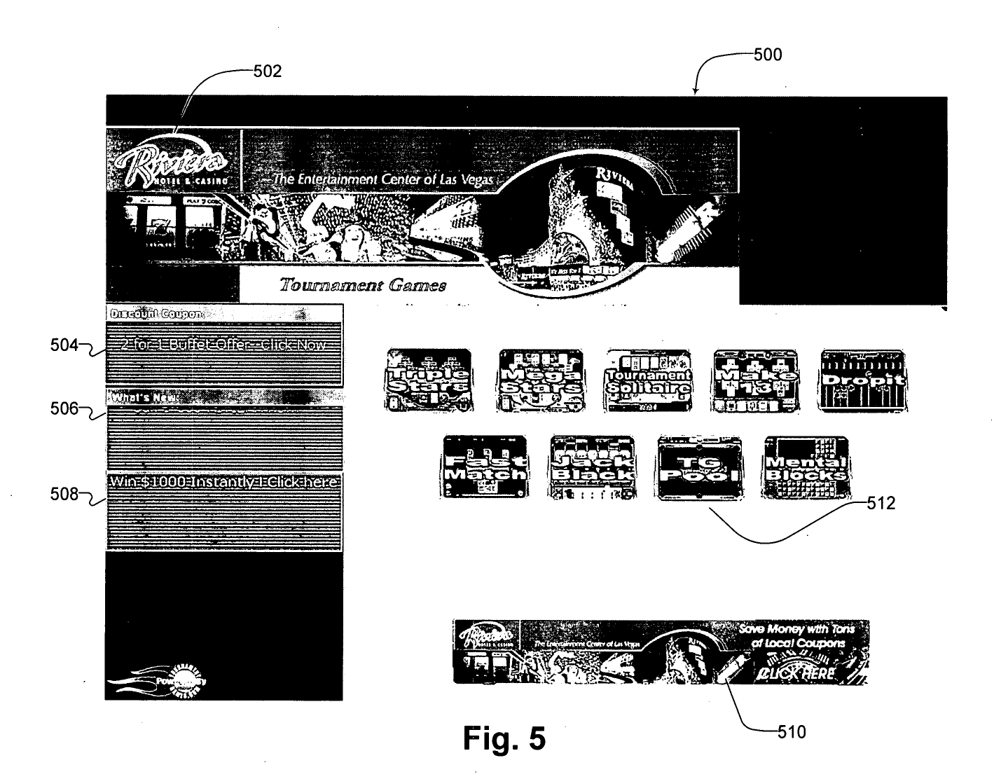

FIG. 5 further illustrates a customer console of the present invention. The customer console 500 has several designated areas that comprise the interface or skin of the present invention. The computer industry defines a “skin” as an overlay that changes the visual appearance of the customer console 500 but retains the underlying functionality of the software program. The skin is a procedure that allows programmers to modify the appearance of the interface and develop several different looks for the software application without affecting the underlying structure or performance of the application. Skins can have elements arranged in different order, different colors, different shapes and many other possibilities. The customer console 500 has a skin that designates the primary elements for display of advertising messages and attraction content. The console 500 is branded toward the Riviera® Hotel and Casino and contains a logo display area 502, discount coupon area 504, news message area 506, contest entry area 508, coupon center banner area 510 and a common attraction area 512. The logo display area 502 is edited and modified by the client 101 through the control panel as previously described and displays the client's 101 logo. The discount coupon area 504 provides the customer 102 with a coupon related to the client's 101 products or services and can be updated by the client 101 using the client 101 control panel as described above. The news message area 506 displays information related to the client's 101 company and current events related to the company. For example, the client 101 could be running a special discount on a premier product and communicate this to the customer 102 in real time. The communication takes place while the customer 102 is using the customer console 500. The contest entry area 508 provides the customer with a link to enter a contest sponsored by the client 101. By activating the contest entry link in area 508, the customer 102 is entered into a contest. In this example, the contest provides the winner, hopefully the customer 102, with a prize of $1,000. Banner area 510 is the link to enter the coupon center 600 described in further detail below. The common attraction area 512 contains access links to the various attractions of the attraction provider 110 in which the customer 102 can participate. In the current example, the common attraction area 512 is based on Internet tournament gaming. Game choices include tournament solitaire, jack black, mental blocks and other games such as pool. Each of these games provides the customer 102 with entertainment value and an interactive gaming environment. It is noted that the present invention is not limited to an attraction of tournament gaming as shown in FIG. 5: rather, the common attraction area 512 may also display links related to other forms of Internet entertainment such as movies, musicals, sports, and other content of the Internet.

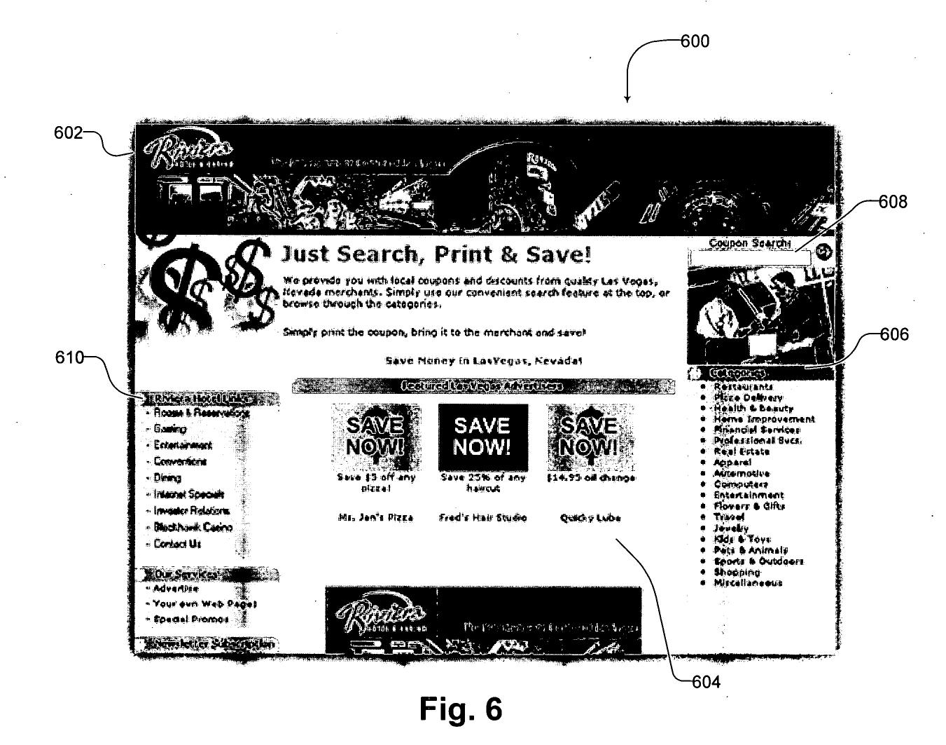

FIG. 6 illustrates the coupon center 600, which is another attraction that encourages the customer 102 to access the customer console 500. The customer 102 accesses the coupon center 600 by activating the banner link contained in the banner area 510 (FIG. 5) on the customer console 500. The coupon center 600 is comprised of specific areas. First, the logo area 602 displays the logo or trademark of the client 101 that sponsors the coupon center. A list of client 101 preferred links is displayed in area 610. A customer 102 uses area 610 to access hyperlinks that relate to specific products or services of the client 101. Area 604 provides coupons that are considered current or daily specials. The customer 102 retrieves a coupon for the daily special by activating the desired link and printing a coupon from the customer's computer 103. A categorized list of available coupons is provided in area 606. In the categorized list, the customer 102 can browse the predefined list of products and services to obtain a desired coupon.

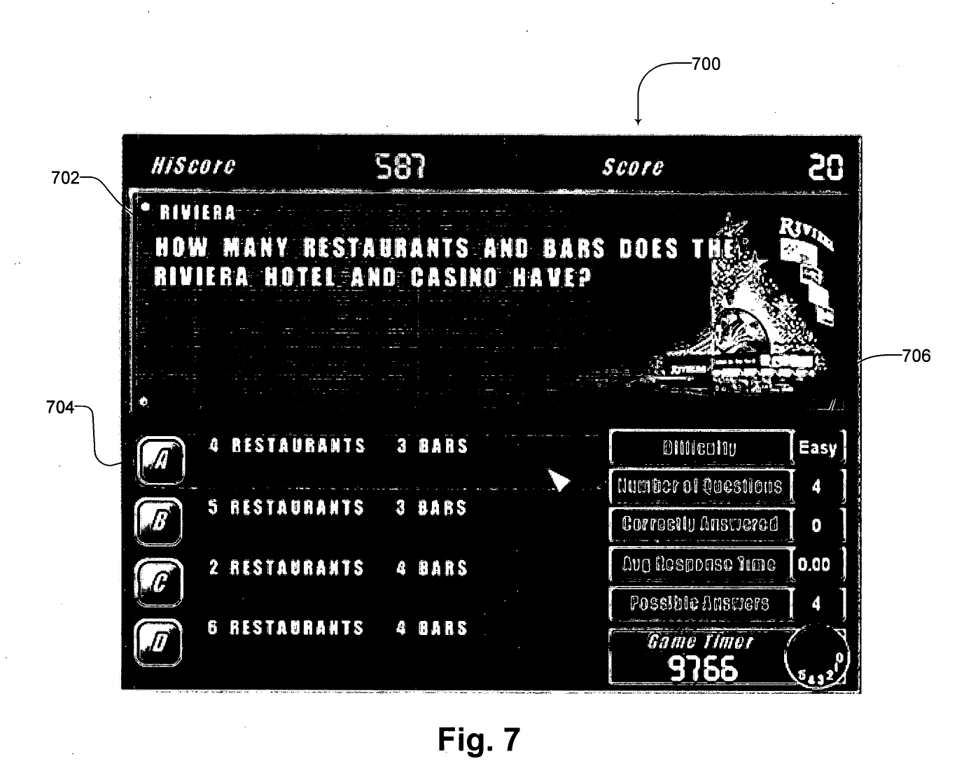

FIG. 7 illustrates a custom Internet based trivia tournament game 700. In the present invention, the client 101 can sponsor a custom tournament game based on trivia related to the client's 101 company or products. Trivia game 700 is an example of such game customization. The customer 102 accesses the trivia game 700 by selecting a designated hyperlink in attraction area 512. The trivia game 700 has a plurality of display areas such as; a trivia question area 702, possible answers area 704, and a game information area 706. The trivia question area 702 is for positing the current trivia question. Possible answers the customer 102 can select are displayed in the answer area 704. The customer 102 indicates an answer to the trivia question by selecting one of the possibilities in answer area 704. Correctly selected answers are indicated in game information area 706. The game information area 706 also displays additional information regarding the trivia game. The customer 102 competes against other customers of the client 101 for prizes sponsored by the client 101. The winner of the trivia game is preferably based upon timely and correctly answering the trivia questions. The customer 102 is notified by obtaining a score that exceeds a predetermined high score. These scores are indicated on the trivia game 700 game console.

In the preferred embodiment, the advertising method and system is coupled with on-line tournament games. The client 101 seeking to enhance business through advertising over the Internet registers and obtains authorization from the marketing service provider 108 to participate in the network-based advertising hosted by the marketing service provider 108. The client 101 is then assigned an identification code by the marketing service provider 108. The client 101 then develops various advertising content directed towards the client's 101 customer base and business requirements. The initially developed content is incorporated into the distributable software by the marketing service provider 108 during the creation of the distributable software. The client 101 distributes the software to the customer 102 base by any appropriate marketing method. These methods include directly giving the software to the customer 102 in person at point of sale, direct mailing of the software, having the customer 102 download the software, permitting the customer 102 to email to another person or directly emailing the software to the customer 102. In methods where the software is physically distributed to the customer 102, it is common to provide the software on a computer readable media such as CD-ROM or DVD.

Upon receiving the distributed software, the customer 102 is enticed to install the application. The client 101 optionally develops an enticement as described above and shown in step 204A that is included with the distribution of the software to the customer base. The enticement of step 204A serves to ensure that the customer 102 installs the software and thus the client 101 will have communication access via the marketing service provider 108 to the customer's computer 103 whenever the customer 102 is accessing the customer console 500. The enticements of step 204A are printed on the software packaging and include: scratch and win tickets, a chance to win an instant money reward, instant rebate or entry in a drawing for a money prize or free gift. Each of the enticements requires a successful installation step 208 and registration step 210 by the customer 102. The ability to enter a drawing is determined by the client 101 and may be designated to run for a specific length of time. In addition, the customer 102 can be permitted by the client 101 to enter the contest multiple times. The client 101 benefits from allowing the customer 102 to enter the contest more than once because each time the customer 102 desires to enter the contest the client's 101 advertising messages are displayed to the customer 102. In addition, the customer 102 benefits from entering the contest multiple times because multiple entries increase the customer's 102 chances of winning the contest. The customer 102 will typically accept the client's 101 advertising messages more favorably because the customer 102 is benefiting from the ability to enter the contest more than once.

The branded customer console shown in FIG. 5 provides the client 101 with a communication portal to the customer 102 when the customer is active in the on-line tournament game or accessing the software to participate in attraction activities. The client's 101 advertisements share a dedicated portion of the customer's computer display 103 while the customer 102 accesses the customer console 500 or participates in the on-line attraction. The customer 102 participates in the on-line tournament game by known methods, which generally include paying an entry fee or selecting a free game. The tournament games are not limited to one specific branded version of the software but rather may include a pool of players comprising several different branded versions each potentially sponsored by a different client. In effect, thousands of different players can compete in a single game with players from hundreds of other branded versions and still receive specific messages from their designated client brand, based on their relationship with that brand. Additionally, the tournament games are captivating and induce the customer 102 to return for subsequent game play. The inducement is facilitated by the customer's 102 competitive nature. For example, regarding the tournament games, the customer 102 is ordinarily limited to entering contests that are based on the customer's skill level for the particular game. In this way, the customer 102 remains competitive with other tournament players and essentially will sometimes win and sometimes lose the game. If the customer 102 were permitted to enter contests that are far beyond the customer's 102 skill level, the customer 102 would have little chance to win the contest. After losing regularly, the customer 102 would quickly loose interest in the tournament game. By ordinarily limiting the customer 102 to participation in just those games that are on the same skill level of the customer 102, the customer 102 has fair competition and it is likely that the interest of the customer 102 in the tournament will be sustained (especially if prompted by winning). The customer 102 may be offered the opportunity to enter games requiring a higher level of skill, but preferably with the provision of notifying the customer 102 that the game is based on players of higher skill. The notification could also include additional incentives or prizes to reduce the risk of discouraging the customer 102 if the customer loses. There is an appeal to benefit financially from participating in the games if the customer 102 is victorious. When the customer 102 registers with the marketing service provider 108 in step 210 the customer 102 may be required to establish a customer account for facilitating financial transactions with the attraction provider 110. The account requirement may depend upon which type of attraction providers the client 101 selects to include in the customer console 500. For example, some attraction providers 110 may charge fees for their services and may provide monetary payments for victorious players. The customer's 102 unique ID code is correlated with any required attraction provider 110 account information. The account information is then shared between the marketing service provider 108 and the attraction provider 110 by one of several known techniques such as; where the marketing service provider 108 embeds the customer's 102 information in the software installed on the customer's computer 103, passing the information through the customer's computer 103 to the attraction provider 110 or possibly by directly providing the information to the attraction provider 110. The customer account established between the attraction provider 110 and the customer 102 enables funds to be securely transferred to and from the attraction provider 110 and customer 102. The secure transfer of funds is essentially to pay attraction provider 110 fees and to pay the customer 102 upon wining a particular attraction event prize. During the process of creating the account, the customer 102 establishes a prepaid account. The account is preferably funded by an electronic funds transfer from a credit card such as a VISA® or a MasterCard® or directly from the customer's 102 bank account.

When the customer 102 chooses to participate in on-line tournament gaming, the customer 102 activates the software in step 212. Upon execution of the software, customer console 500 is displayed on the customer's computer 103. The software first establishes a bi-directional communication link between the marketing service provider 108 and the customer's computer 102. Then a second bi-directional link is established between the attraction provider 110 and the customer's computer 102. The customer console 500 is divided into two functional portions: the attraction provider 110 portion 512 (see FIG. 5) that is a primary portal to the on-line tournament gaming; and client 101 portion with a plurality of display areas 502, 504, 506, 508 and 510 that are display areas for the client's 101 advertising messages. The client 101 can send dynamically updated advertising messages to the customer 102 which are then displayed in the designated client 101 portion display areas 502, 504, 506, 508, and 510. So long as customer computer 103 is linked over the network to the marketing service provider 108, the customer-installed software continually queries for updates to the advertising content shown in step 218 while the customer 102 participates in the on-line tournament game. The client 101 is able to dynamically update the advertising content by using the client control panel 310. When the client 101 securely updates the content, this content is uploaded to the marketing service provider 108, stored in database 120 and subsequently sent over the network for display on the customer's computer 103. This dynamic communication and update query of step 218 takes place in continuous real-time while the customer 102 is connected to the marketing service provider 108 via the network.

In an alternative embodiment, there is a secondary attraction for the customer 102 that provides discount coupons from local merchants and businesses. The functionality of the customer's 102 computer-based software essentially remains similar in that the creation, distribution, registration, installation, searching for updates and displaying updates is the same as already described. However, there is another provision for attracting the customer 102 to execute the software and participate in the primary attraction. In this alternative embodiment, the customer 102 executes the customer-installed software to obtain monetary discounts by way of coupons for various goods and services. The software installed by customer 102 in step 208 provides a coupon center 600 (see FIG. 6) where the customer 102 can search or browse for coupons from local area businesses. The businesses that participate in the coupon center 600 are non-competitive to the client 101 and provide various goods or services the customer 102 may desire. For example, client 101 may be an automobile dealer, and the coupon center 600 may provide a customer 102 with coupons from a local restaurant, local dry cleaner or a local jewelry store. The coupon center 600 is sponsored by the client 101 as a supplemental attraction for the customer 102. The coupons offered in the coupon center 600 are independent of coupons specifically provided by client 101. The customer 102 subsequently is likely to appreciate the discounts and associate the discounts as coming from the client's 101 good will. The available coupons in the coupon center 600 may be aggregated by a secondary attraction provider 110 that specializes in contacting local businesses for participation in mass-marking coupon campaigns. The coupon center 600 contains a plurality of designated areas that facilitate the searching of specific coupons by the customer. Daily special coupons are displayed in designated area 604 for enhanced promotion for the local business and quick access for the customer 102. Area 606 consists of a categorized list of coupons available for the customer 102 to access. The client 101 has a designated area 610 in the coupon center 600 that provides the customer 102 with a categorized list of coupons available from the client 101. Upon finding a desired coupon, the customer 102 prints the coupon from the customer's personal computer 103. The coupon is hosted on the marketing service provider 108 server 118. The coupons are accessed through the bi-directional communication link that is active between the marketing service provider 108 and the customer 102 while the customer 102 is accessing the coupon center 600. The client 101 is permitted to send updated advertising messages by way of the marketing service provider 108 to the customer 102 whenever the customer 102 accesses the customer console 500 (see FIG. 5). Additionally, the coupon center attraction provider 110, which provides the content for the coupon center 600, can also send updated coupon content because the bi-directional communication link between the coupon center attraction provider 110 and customer computer 103 is active. In addition, the businesses that provide the various coupons can update and modify their respective coupons and the content of those coupons.

As will now be apparent, the invention provides many advantages absent from known Internet advertising techniques. For example, the invention enables a client 101 at any time to send new advertising messages to a customer 102. Additionally, the client 101 can securely access the marketing service provider 108 at any time to create, edit and modify advertising messages. The client 101 can perform the modification from any computer having network access upon successful login with the marketing service provider 108. The ability of the client 101 to independently modify the advertising messages affords the client 101 distinct benefits, such as: quicker implementation by reducing the involvement from the marketing service provider 108 personnel, substantial cost reduction because the client 101 is performing the modification (essentially, any employee of client 101 with basic computer skills can perform a modification) and enhanced client 101 control over the breadth and frequency of the modifications.

Another substantial advantage of the invention is that the client's 101 advertising messages are provided to the customer 102 in an environment exclusive to the client 101. Contrary to known advertising techniques, the client 101 designated display areas 502, 504, 506, 508 and 510 are exclusive to only the client 101 and cannot display the advertising messages from a competing business entity. Compare this to traditional media outlets, where one business runs an advertisement that is subsequently followed by a competing advertisement from another business. This is termed message clutter and is common in the traditional media outlets. For example, in television advertisements, multiple competing automobile dealers' advertisements may run back to back and are in direct competition with each other for the customer's attention. The current invention maximizes the client's 101 advertising message impact upon the customer 102 due to the exclusive client 101 advertising environment.

Furthermore, the invention provides a vehicle for the client 101 to submit a multiplicity of advertising messages in both form and content to a customer 102 and have them favorably received by the customer 102. This advantage is effectuated by the fact that the customer 102 is not being sent only advertisements but is provided substantial attractions that are of interest to the customer 102. Likewise, the customer 102 perceives the provision of the attractions as a gesture of the client's 101 good will and this favorable perception is blended with the client's 101 advertising messages and the attraction. Thus, the customer 102 evaluates the advertising messages from a positive perspective because the customer 102 is contemporaneously enjoying the attraction.

Still another significant advantage of the invention is the provision that the client 101 can differentiate specific groups of customers 102 for enhanced and focused advertising messages particularly suited for a specific customer group. This advantage is accomplished by assigning the client 101 two or more identification codes in step 204 either at initial authorization or subsequent to the client's 101 initial involvement with the marketing service provider 108. In this case, each of the multiple identification codes is individually assigned to a different designated version of the distributable software. The marketing service provider then prepares the software, wherein each software copy is assigned one of the identification codes and afterward this software is only distributed to a specific customer group. For example, a client 101 can be assigned two unique identification codes where one code is designated for direct mail customers 102 and the other code is assigned to established customers 102. The marketing service provider then prepares two version of the distributable software: one for direct mail customers 102 and the other for established customers 102. Once the two versions are distributed to the client's 101 customers 102 in step 206, the client 101 can then update the advertising messages independently. This enables the client 101 to send different advertising messages to the direct mail customers 102 than to the established customers 102. Correspondingly, the client 101 can specifically customize and send advertising messages to the direct mail customers 102 that are more inclined to bring the direct mail customer 102 into the client's 101 place of business. The client 101 can, at the same time, customize and send to the established customer 102 advertising messages that favor the existing customer and entice this customer group to frequent the client's 101 business. Furthermore, the client 101 has the ability to modify a customer's 102 designation or association from one group to another. This enables the client 101 to update the customer's 102 group association as the customer 102 changes status. For example, a customer 102 may initially be a direct mail customer but over time may become an established customer. In this way the client 101 has the ability to send the appropriate advertising messages to the customer 102 as the customer's status changes.

Appendix A contains a document entitled REACT case study/product overview, which is hereby incorporated by reference. This document contains a concise overview and explanation of the current invention. The document provides additional information on the specific advantages of the invention as well as additional examples of various embodiments. Also contained in the case study are additional figures and illustrations on the invention illustrating various functions and features.

Although the above provides a full and complete disclosure of the preferred embodiment of the invention, various modifications, alternate constructions and equivalents will occur to those skilled in the art. For example, although the invention has been described with reference to specific entertainment attractions, other types of such attractions can be utilized as desired. Moreover, different types of communication networks can be used to practice the invention. Therefore, the above should not be construed as limiting the invention, which is defined by the appended claims.

What is claimed is:

1. A method for presenting an attraction and an advertising message on the display of a customer computer having access to a network, said method comprising the steps of:
(a) providing a customer computer with computer software enabling the customer to contemporaneously access a marketing service provider and an attraction provider via a network;
(b) storing an advertising message with the marketing service provider; and
(c) displaying an attraction and an advertising message on the customer computer when the computer software is activated by the customer and the customer computer is coupled to the marketing service provider and the attraction provider via the network.

2. The method of claim 1 wherein said step (a) of providing includes the step of including an initial advertising message in the computer software; and wherein said step (c) of displaying includes the step of displaying the initial advertising message when the computer software is activated by the customer.

3. The method of claim 1 further including the step of requiring the customer to obtain a unique customer identification before permitting the display of said attraction.

4. The method of claim 3 wherein said step of requiring includes the steps of coupling the customer computer to the marketing service provider upon initial activation of the computer software, and conducting an initial registration procedure between the customer computer and the marketing service provider.

5. The method of claim 1 further including the steps of (i) preparing a revised advertising message, (ii) storing the revised advertising message with the marketing service provider, and (iii) downloading the revised advertising message from the marketing service provider to the customer computer via the network.

6. The method of claim 5 wherein said step of preparing a revised advertising message includes the steps of permitting a third party client to access the marketing service provider, and conducting an advertising message revision procedure between the third party client and the marketing service provider.

7. The method of claim 6 wherein said step of conducting an advertising message revision procedure includes the step of enabling the third party client to supply revised advertising message information to the marketing service provider.

8. The method of claim 7 wherein said step of permitting includes the step of requiring the third party client to obtain at least one unique user identification before performing said step of conducting an advertising message revision procedure.

9. The method of claim 5 wherein said step (iii) of downloading is performed after said step (ii) of storing when the customer computer is currently coupled to the marketing service provider.

10. The method of claim 5 wherein said step (iii) of downloading is performed when the customer computer is subsequently coupled to the marketing service provider if the customer computer is not currently coupled to the marketing service provider when said step (ii) of storing is performed.

11. The method of claim 5 wherein said step (a) of providing includes the step of providing the software with a customer group identification designator; said step (i) of preparing includes the step of correlating the revised advertising message to the customer group identification designator; and said step (iii) of downloading includes the step of transmitting the revised advertising message to only those customers having software provided with said customer group identification designator.

12. The method of claim 11 wherein said step of providing said customer group identification designator includes the step of enabling the third party client to modify said customer group identification designator.

13. The method of claim 1 further including the steps of displaying the attraction and the advertising message in different predetermined regions of the display of the customer computer.

14. An advertising system for displaying current advertising messages prepared by a client and stored by a marketing service provider, said system comprising:
a customer computer operatively connected to a marketing service provider and an attraction provider via a network, said customer computer having a display;
said customer computer having a software program installed therein provided by said client; said software program containing a first module for receiving current advertising message sent from said marketing service provider, and a second module for receiving an information update from said attraction provider concurrently running on said customer computer; said software program further including a customer console for displaying said current advertising message in at least one of a plurality of client dedicated areas of said display and for displaying said information update from said attraction provider in a different area of said display; said software program simultaneously displaying both said current advertising message and said information update on said display of said customer computer.

15. An advertising system as per claim 14, wherein said client is assigned at least one unique identification code by said marketing service provider for controlling access to said current advertising message.

16. An advertising system according to claim 14, wherein the attraction provider is selected from the group consisting of an on-line tournament game, an on-line movie content, an on-line music content, an on-line discount coupon center, an on-line travel center, and on-line sports content, and an on-line music content.

17. An advertising system according to claim 16, wherein the on-line tournament game provides a selection of games based on player skill-level.

18. An advertising system according to claim 14, wherein said software program contains an incentive for the customer to install the client provided software program.

19. An advertising system according to claim 14, wherein said dedicated display areas are preferably only assigned to one said client.

20. An advertising system according to claim 14, wherein said program is provided with a customer group identification designator; and wherein said current advertising message is transmitted by said marketing service provider to only a customer computer having software associated with said customer group identification designator.

21. An advertising system according to claim 20, wherein said client is enabled to modify said customer group identification designator.
